(19) United States
(12) Patent Application Publication
(10) Pub. No.: US 2008/0156229 A1
(43) Pub. Date: Jul. 3, 2008

(54) PROCESSES FOR THE HYDROTHERMAL PRODUCTION OF TITANUIM DIOXIDE

(75) Inventors: DAVID RICHARD CORBIN, WEST CHESTER, PA (US); KEITH W. HUTCHENSON, LINCOLN UNIVERSITY, PA (US); SHENG LI, ELMHURST, NJ (US); CARMINE TORARDI, WILMINGTON, DE (US); EUGENE MICHAEL MCCARRON, GREENVILLE, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DUPONT DE NEMOURS AND COMPANY, WILMINGTON, DE (US)

(21) Appl. No.: 11/617,275

(22) Filed: Dec. 28, 2006

(51) Int. Cl. C09C 1/36

(52) U.S. Cl. 106/442; 106/436; 106/449

(57) ABSTRACT

The present invention provides hydrothermal processes for the production of titanium dioxide from titanyl hydroxide. The use of specific crystallization directors, or additives, can promote the formation of rutile, anatase, or brookite. Variation of process operating parameters can lead to either pigmentary-sized or nano-sized rutile.

### FIELD OF THE INVENTION

The present invention relates to processes for the hydrothermal production of titanium dioxide from titanyl hydroxide.

### BACKGROUND

Titanium dioxide (TiO₂) is used as a white pigment in paints, plastics, paper, and specialty applications. Ilmenite is a naturally occurring mineral containing both titanium and iron with the chemical formula FeTiO₃.

Two major processes are currently used to produce TiO₂ pigment—the sulfate process as described in “Haddeland, G. E. and Morikawa, S., “Titanium Dioxide Pigment”, SRI international Report #117” and the chloride process as described in “Battle, T. P., Nguygen, D., and Reeves, J. W., The Paul E. Queneau International Symposium on Extractive Metallurgy of Copper, Nickel and Cobalt, Volume I: Fundamental Aspects, Reddy, R. G. and Weizenbach, R. N. eds., The Minerals, Metals and Materials Society, 1993, pp. 925-943”.

Lahti et al (GB 2221901 A) disclose a process for the production of titanium dioxide pigment including hydrothermal crystallization in an aqueous acid medium below 300° C. Crystallization aids are mentioned, but the compositions of the crystallization aids are not given.

The present invention provides a hydrothermal crystallization process for the production of titanium dioxide. The use of specific crystallization directors, or additives, promotes the formation of rutile, anatase, or brookite. Variation of process operating parameters can lead to either pigmentary-sized or nano-sized rutile.

### SUMMARY OF THE INVENTION

One aspect of the present invention is a process comprising:
a) mixing amorphous titanyl hydroxide with water to obtain a titanium-containing slurry;
b) adding to the titanium-containing slurry 0.16 to 20 weight percent of a free acid selected from the group consisting of HCl, H₂C₂O₄.2H₂O, HNO₃, HF, and HBr to form an acidified titanium-containing slurry;
c) adding to the acidified titanium-containing slurry 0.01 to 15 weight percent of a rutile-directing additive to form a mixture;
d) heating the mixture to a temperature of at least 150° C. but less than 374° C. for less than 24 hours in a closed vessel to form rutile and a residual solution; and
e) separating the rutile from the residual solution.

Another aspect of the present invention is a process comprising:
a) mixing amorphous titanyl hydroxide with water to obtain a titanium-containing slurry;
b) adding to the titanium-containing slurry 0.16 to 0.41 wt % of a free acid selected from the group consisting of HCl, HNO₃, HF, H₂C₂O₄.2H₂O, and HBr to form an acidified titanium-containing slurry;
c) adding to the acidified titanium-containing slurry 0.5 to 15 weight percent of a pigmentary rutile-directing additive to form a mixture;
d) heating the mixture to a temperature of at least 220° C. but less than 374° C. for 24 hours or less in a closed vessel to form pigmentary rutile and a residual solution; and
e) separating the pigmentary rutile from the residual solution.

A further aspect of the present invention is a process comprising:
a) mixing amorphous titanyl hydroxide with water to obtain a titanium-containing slurry;
b) optionally adding less than 0.16 wt % of an acid selected from the group consisting of HCl, HF, HBr, HNO₃, and H₂C₂O₄.2H₂O or up to 20 wt. % of H₂SO₄ to the titanium-containing slurry to form an acidified slurry;
c) adding 0.01-15 weight percent of an anatase-directing additive to the slurry to form a mixture;
d) heating the mixture to a temperature of at least 150° C. but less than 374° C. for 24 hours or less in a closed vessel to form anatase and a residual solution;
e) separating the anatase from the residual solution.

These and other aspects of the present invention will apparent to one skilled in the art in view of the following disclosure and the appended claims.

### BRIEF DESCRIPTION OF THE DRAWINGS

FIG. 1 is a scanning electron micrograph (SEM) image of pigmentary rutile TiO₂ produced hydrothermally at 250° C. in an embodiment of the present invention.

FIG. 2 is a scanning electron micrograph (SEM) image of silica/alumina surface-coated rutile TiO₂ product according to an embodiment of the present invention.

FIG. 3 is an X-ray powder pattern of hydrothermal synthesized TiO₂ containing about 80% brookite according to an embodiment of the present invention.

FIG. 4 shows the particle size distribution of TiO₂ product synthesized from TiOSO₄-derived titanyl hydroxide at 250° C. vs. commercial chloride process pigmentary rutile according to an embodiment of the present invention.

### DETAILED DESCRIPTION

Titanium dioxide is known to exist in at least three crystalline mineral forms: rutile, anatase, and brookite. Rutile crystallizes in the tetragonal crystal system (P42/mnm with a=4.582 Å, c=2.953 Å); anatase crystallizes in the tetragonal crystal system (I41/amd with a=3.7852 Å, c=9.5139 Å); brookite crystallizes in the orthorhombic crystal system (Pcab with a=5.4558 Å, b=9.1819 Å, c=5.1429 Å). The particle size of titanium dioxide influences the opacity of products utilizing TiO₂. Titanium dioxide product in the particle size range 100 to 600 nanometers is desired for use as pigment. Titanium dioxide with a particle size less than 100 nanometers is referred to as nano-sized.

Hydrothermal crystallization involves conversion of an amorphous titanyl hydroxide intermediate to titanium dioxide in the presence of water at relatively mild temperature conditions compared to the calcination temperatures (ca. 1000° C.) typically utilized in commercial titanium dioxide production. Titanyl hydroxide (titanic acid) is believed to exist as TiO(OH)₂ (beta- or meta-titanic acid), Ti(OH)₄ or TiO(OH)₂.H₂O (alpha- or ortho-titanic acid) or TiO(OH)₂.xH₂O (where x>1). [J. Barksdale, Titanium: Its Occurrence, Chemistry, and Technology, 2^{nd} Ed., Ronald Press: New York (1966)]. Titanyl hydroxide can be produced by either of the known commercial processes for titanium dioxide production, the chloride process or the sulfate process. Additionally, titanyl hydroxide can be produced by other processes which have not yet been commercialized, such as extraction of titanium-rich solutions from digestion of ilmenite by hydrogen ammonium oxalate. Reaction temperatures in the hydrothermal crystallization process range from as low as 150° C. up to the critical point of water (374° C.) with reaction pressures on the order of the corresponding vapor pressure of water. Reaction times are less than 24 hours. The use of specific phase-directing crystallization aids, or additives, can be used to control the titanium dioxide phase and morphology produced. Variation of the range of process conditions such as control of the acid concentration in the reaction mixture can be used to selectively control the resulting titanium dioxide particle size, crystallography, and morphology.

The rutile phase of titanium dioxide can be formed at 150 to 374° C. with the addition of rutile-directing additives. Rutile-directing additives are those that promote the formation of the rutile TiO₂ phase in the crystallized product. Examples of rutile-directing additives include the halides, oxalates, oxides, and hydroxides of zinc, tin, ammonium, and the group I and group II metals. Pigmentary rutile titanium dioxide can be produced at 220 to 374° C. with the addition of pigmentary rutile-directing additives. Pigmentary rutile-directing additives are those that promote the formation of the rutile TiO₂ phase in the crystallized product, with the product particle size in the desired pigmentary particle size range of 100-600 nm. Examples of pigmentary rutile-directing additives include the rutile-directing additives disclosed herein above. Preferred examples of pigmentary rutile-directing additives include ZnCl₂, ZnO, MgCl₂, and NaCl. Nano-sized rutile titanium dioxide can be produced with the addition of any one of the previously mentioned rutile-directing additives at temperatures as low as 150° C.

The anatase phase of titanium dioxide can be produced at similar process temperatures with the addition of anatase-directing additives. Anatase-directing additives are those that promote the formation of the anatase TiO₂ phase in the crystallized product. Examples of anatase-directing additives include KH₂PO₄, Al₂(SO₄)₃, ZnSO₄, and Na₂SO₄. The brookite phase of titanium dioxide can be produced at temperatures of 150 to 374° C. with the use of brookite-directing additives. Brookite-directing additives are those that promote the formation of the brookite TIO₂ phase in the crystallized product. Examples of brookite-directing additives include AlCl₃.6H₂O, alpha-Al₂O₃, Al(OH)₃, and AlOOH.

The processes of the present invention for the production of rutile include mixing titanyl hydroxide with water to form a slurry. After mixing the titanyl hydroxide with water, the resulting slurry is acidified by addition of a specified concentration of free acid. Free acid is defined herein as the amount of acid above what is needed to neutralize any residual basic species remaining in the titanyl hydroxide from prior processing. The acid and free acid concentration is selected to facilitate the phase-directing action of the additives noted above as well as to control the resulting TiO₂ particle size. For producing rutile TiO₂, the added acid may be selected from the group HCl, HNO₃, HF, HBr, or H₂C₂O₄.2H₂O. The concentration of the acid can affect the resulting particle size of the titanium dioxide obtained from the process. The process of the present invention can produce either nano-sized or pigmentary-sized rutile titanium dioxide. Increasing acid concentration tends to decrease the particle size of the resulting titanium dioxide. Pigmentary-sized particles have a large market and thus are frequently the desired particle size.

To the acidified slurry is added a phase-directing additive in a concentration of 0.01 to 15 weight percent to form a mixture. Phase directing additives such as those cited previously aid in crystallization of the desired phase and in controlling the resulting particle morphology.

The mixture containing the phase directing additive and the acidified slurry is then charged into a closed vessel and heated to a temperature of at least 150° C. and less than the critical point of water (374° C.). The pressure developed in the autoclave is the vapor pressure of the mixture, which is approximately the vapor pressure of the major constituent, water. The mixture is held at temperature for 24 hours or less. This procedure is referred to as a hydrothermal treatment. The time at temperature is a factor in determining the particle size of the resulting titanium dioxide, where in general, depending upon the reaction conditions, increasing time at temperature leads to increasing particle size.

During the hydrothermal treatment in the closed vessel, the charged mixture is converted to the desired phase of titanium dioxide and a residual solution. The titanium dioxide may be separated from the residual solution using standard techniques such as filtration or centrifugation. Titanium dioxide is frequently supplied to the pigment market with a coating such as silicon and aluminum oxides which may be added in an additional process step.

To produce anatase, the above described processes for rutile production are followed except the phase-directing additive is replaced by an anatase-directing additive, as disclosed herein above. The addition of acid is optional but less than 0.16 wt % of an acid selected from the group HCl, HF, HBr, HNO₃, and H₂C₂O₄.₂H₂O may be added to the slurry, or up to 20 wt % H₂SO₄.

If the brookite phase is desired, the above described process for rutile production is followed except an NH₄OH or NH₃ solution is added to the titanium-containing slurry to raise its pH to greater than 9, and the phase-directing additive is replaced by a brookite-directing additive, as disclosed herein above. The brookite phase is usually formed as a mixture of brookite, anatase, and rutile along with a residual solution.

### EXAMPLES

### Example 1

Preparation of a Titanyl Hydroxide Precipitate from Reagent Grade Ammonium Titanyl Oxalate

A mixture containing 150 g of a reagent grade ammonium titanyl oxalate monohydrate (Acros; CAS#10580-03-7) and 1200 g of deionized water was added to a 4 L glass beaker. The mixture was agitated by a magnetic stir bar for 30 minutes at room temperature and filtered via a 0.45 μm disposable nylon filter cup to remove any insoluble impurities. The filtrate was collected and transferred back into the 4 L glass beaker and heated to 80° C. on a hot plate with constant agitation. Concentrated NH₄OH (28-30 wt % NH₃; CAS#1336-21-6) was gradually added to titrate the ammonium titanyl oxalate solution to pH 8.0-8.3, while the temperature of the mixture was maintained at 80° C. The reaction mixture was kept at temperature for an additional 15 minutes and then filtered via a 24 cm #54 Whatman paper filter to yield 463 g of titanyl hydroxide precipitate. The titanyl hydroxide precipitate was collected and reslurried with 2 L of deionized water at room temperature. The mixture was heated to 60° C. on a hot plate with agitation and held at this temperature for 20 minutes. A small amount of concentrated NH₄OH solution was added to maintain the solution pH at 8.0-8.3. The solution was then filtered via a 24 cm #54 Whatman paper filter to yield 438 g of wet titanyl hydroxide cake. The wet cake was then washed by resuspending the material in 2 L of deionized water and filtering at room temperature to remove residual oxalate. The washing step was repeated until the conductivity of the filtration liquid dropped below 100 μS. The resulting titanyl hydroxide precipitate had an estimated solid content of 10wt % and was found to have an amorphous X-ray powder pattern with no distinctive anatase-like or rutile-like peaks. Elemental C—N analysis revealed that the synthesized titanyl hydroxide precipitate contained 0.2% C and 2.7% N on a dry basis.

### Example 2

Hydrothermal Crystallization of Nano-Size Rutile TiO₂ from Reagent Grade Ammonium Titanyl Oxalate Derived Titanyl Hydroxide Precipitate

A mixture consisting of 4 g of a reagent grade ammonium titanyl oxalate derived titanyl hydroxide precipitate (refer to Example 1 for precipitate preparation and characterization), 0.0102 g of ZnCl₂ (reagent grade, CAS# 7646-85-7), and 3.9 g of a dilute HCl solution was diluted with deionized water to a concentration of 4 grams of TiO₂ per 100 grams of slurry. The dilute HCl solution was prepared by combining 2.8 g of a 12.1N reagent grade HCl solution (CAS# 7647-01-0) and 32.6 g of deionized water. The mixture containing the titanium precipitate was added to a 10 mL gold tube with a welded bottom. The top of the gold tube was then crimped, and the tube was inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. This added argon pressure, along with the autogenous hydrothermal pressure was contained inside the sealed reaction vessel. The reactor was heated to an internal temperature of 250° C. via the use of an external electrical heating jacket and held at this temperature for 8 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours to yield 0.3 g of TiO₂ powder. The recovered TiO₂ product was 100% rutile with an average crystal domain size of 34 nm as determined by X-ray powder diffraction. The material had a mono-modal particle size distribution and a d₅₀ of 131 nm (d₁₀=92 nm; d₉₀=197 nm). Scanning electron microscopy images confirmed that the primary particles of the synthesized TiO₂ product were of nano-size on the order of 150 nm.

### Example 3

Hydrothermal Crystallization of Pigmentary Rutile TiO₂ at 250° C. from Reagent Grade Ammonium Titanyl Oxalate Derived Titanyl Hydroxide Precipitate (10 mL Scale)

A mixture consisting of 4 g of a reagent grade ammonium titanyl oxalate derived titanyl hydroxide precipitate (refer to Example 1 for precipitate preparation and characterization), 0.0582 g of ZnCl₂ (reagent grade, CAS#7646-85-7), and 2.1 g of a dilute HCl solution was diluted with deionized water to a concentration of 4 grams of TiO₂ per 100 grams of slurry. The dilute HCl solution was prepared by combining 2.8 g of a 12.1N reagent grade HCl solution (CAS#7647-01-0) and 33.3 g of deionized water. The mixture containing the titanium precipitate was added to a 10 mL gold tube with a welded bottom. The top of the gold tube was then crimped, and the tube was inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. This added argon pressure, along with the autogenous hydrothermal pressure was contained inside the sealed reaction vessel. The reactor was heated to an internal temperature of 250° C. via the use of an external electrical heating jacket and held at this temperature for 16 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours to yield 0.3 g of TiO₂ powder. The recovered TiO₂ product was 100% rutile with an average crystal domain size of 54 nm as determined by X-ray powder diffraction. The particle size distribution of the material had a d₁₀ of 220 nm, d₅₀ of 535 nm, and d₉₀ of 930 nm. Scanning electron microscopy images confirmed that the primary particles of the synthesized TiO₂ product were of pigmentary size on the order of 200-500 nm.

### Example 4

Hydrothermal Crystallization of Pigmentary Rutile TiO₂ at 250° C. from Reagent Grade Ammonium Titanyl Oxalate Derived Titanyl Hydroxide Precipitate (1 L Scale)

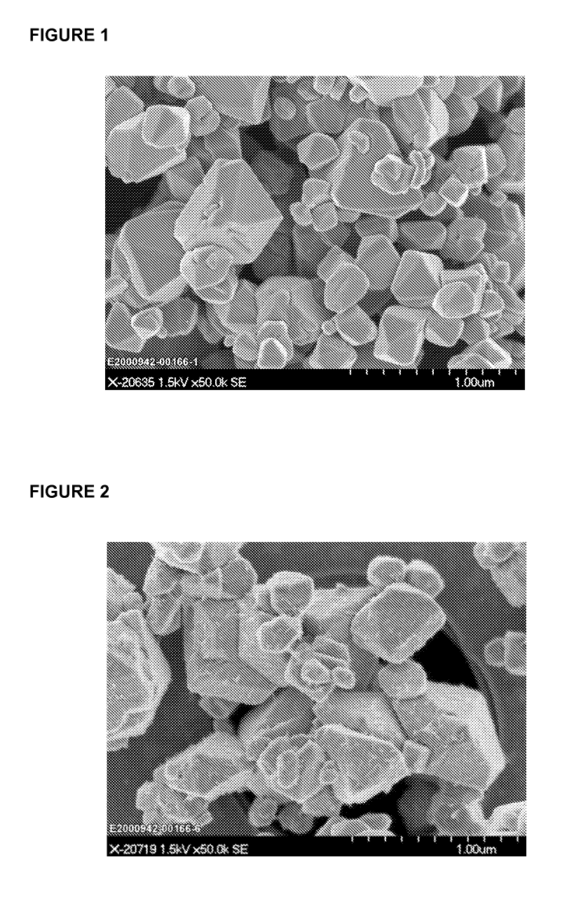

A mixture consisting of 140 g of a reagent grade ammonium titanyl oxalate derived titanyl hydroxide precipitate (refer to Example 1 for precipitate preparation and characterization), 2.2182 g of ZnCl₂ (reagent grade, CAS#7646-85-7), 7 g of a 12.1N reagent grade HCl solution (CAS#7627-01-0), and 175 g of deionized water was added to a 1 L Zr-702 pressure vessel. 50 psig argon pressure was brought into the reactor prior to heat-up. The added argon pressure, along with the autogenous hydrothermal pressure was contained inside the sealed reaction vessel. The reaction mixture was agitated by a pitch blade impeller at a constant speed of 130 rpm. The reactor was heated to an internal temperature of 250° C. via the use of an external electrical heating jacket and held at this temperature for 16 hours. The reactor internal temperature was measured by a thermocouple inside the reactor thermowell, which was immersed in the reaction mixture. After the completion of the hydrothermal crystallization reaction, the TiO₂ slurry was recovered from the zirconium reactor and found to have a pH of 1.1. It was then filtered at room temperature via a 0.2 μm disposable nylon filter cup and washed thoroughly with deionized water to yield 20.11 g of a wet TiO₂ cake with an estimated solid content of 55 wt %. The TiO₂ produced was 100% rutile with an average crystal domain size of 55 nm as determined by X-ray powder diffraction. The material had a mono-modal particle size distribution and a d₅₀ of 802 nm (d₁₀=453 nm; d₉₀ =1353 nm). The primary particles of the synthesized TiO₂ product were pigmentary in size on the order of 200-500 nm as determined by scanning electron microscopy (see FIG. 1).

The pigmentary rutile TiO₂ was then surface treated via a standard chloride-process technology to encapsulate the TiO₂ base material with a silica/alumina coating. X-Ray fluorescence spectroscopy of the coated product indicated a SiO₂ composition of 3.1 wt % and an Al₂O₃ composition of 1.5 wt %. The material had an acid solubility value of 0.2% (relative to a commercial specification of <9%), which indicated the production of a photo-durable TiO₂ product. Scanning electron microscopy images of the surface treated TiO₂ confirmed the uniform deposition of the silica/alumina coating on the TiO₂ particles (see FIG. 2).

### Example 5

Hydrothermal Crystallization of Pigmentary Rutile TiO₂ at 250° C. from Capel Ilmenite Ore Derived Titanyl Hydroxide Precipitate

A mixture consisting of 2.7 g of a Capel ilmenite ore (Iluka, Australia) derived titanyl hydroxide precipitate (15 wt % solid), 0.0583 g of ZnCl₂ (reagent grade, CAS#7646-85-7), and 3.2 g of a dilute HCl solution was diluted with deionized water to a concentration of 4 grams of TiO₂ per 100 grams of slurry. The dilute HCl solution was prepared by combining 2.8 g of a 12.1N reagent grade HCl solution (CAS#7647-01-0) and 48.9 g of deionized water. The mixture containing the titanium precipitate was added to a 10 mL gold tube with a welded bottom. The top of the gold tube was then crimped, and the tube was inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. This added argon pressure, along with the autogenous hydrothermal pressure was contained inside the sealed reaction vessel. The reactor was heated to an internal temperature of 250° C. via the use of an external electrical heating jacket and held at this temperature for 24 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours to yield 0.25 g of TiO₂ powder. The recovered TiO₂ product was 94% rutile with an average crystal domain size of 45 nm as determined by X-ray powder diffraction. Scanning electron microscopy images of the TiO₂ product revealed primary particles of super-pigmentary size, on the order of 500-1000 nm. The material exhibited a bi-modal particle size distribution with a significant percentage of the particles in the pigmentary range of 500-1000 nm (d₁₀=104 nm; d₅₀=610 nm; d₉₀=1199 nm).

### Example 6

Lower Temperature (≦235° C.) Hydrothermal Crystallization of TiO₂ from Reagent Grade Ammonium Titanyl Oxalate-Derived Titanyl Hydroxide Precipitate

A mixture consisting of 4 g of a reagent grade ammonium titanyl oxalate derived titanyl hydroxide precipitate (refer to Example 1 for precipitate preparation and characterization), 0.0582 g of ZnCl₂ (reagent grade, CAS#7646-85-7), and a small amount (as shown in Table 6-1) of a dilute HCl solution was diluted with deionized water to a concentration of 4-5 grams of TiO₂ per 100 grams of slurry. The dilute HCl solution was prepared by combining 2.8 g of a 12.1N reagent grade HCl solution (CAS#7647-01-0) and 32.6 g of deionized water. The mixture containing the titanium precipitate was added to a 10 mL gold tube with a welded bottom. The top of the gold tube was then crimped, and the tube was inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. The added argon pressure, along with the autogenous hydrothermal pressure was contained inside the sealed reaction vessel. The reactor was heated to an internal temperature as specified in Table 6-1 via the use of an external electrical heating jacket and held at this temperature for 24 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours, and the resulting TiO₂ powder was characterized by X-ray powder diffraction and particle size distribution. The product characterization data showed that a pigmentary rutile TiO₂ product was produced at a hydrothermal temperature of 235° C. (6-A). Scanning electron microscopy images of the material confirmed that its primary particles were of pigmentary size on the order of 200-500 nm. A nano-size rutile TiO₂ product with a mono-modal particle size distribution was observed at 220° C. (6-F). Lowering the reaction temperature further to 200° C. favored the formation of the anatase phase (6-G); however, the percent of nano-size rutile in product was found to improve with increasing HCl concentration (6-I).

TABLE 6-1
Lower Temperature (≦235° C.) Hydrothermal
Crystallization of TiO₂

| | | | TiO₂ Product | | |
|---|---|---|---|---|---|
| | Rxtn. | Dilute | | Domain | |
| | Temp. | HCl | Phase | Size | d₅₀ |
| Sample | (° C.) | (g) | (% Rutile) | (nm) | (nm) |
| 6-A | 235 | 2.0 | 99 | 59 | 548 |
| 6-B | 235 | 2.4 | 100 | 51 | 350 |
| 6-C | 235 | 3.0 | 100 | 38 | 144 |
| 6-D | 220 | 2.0 | 68 | 44 | 191 |
| 6-E | 220 | 2.4 | 94 | 39 | 156 |
| 6-F | 220 | 3.0 | 100 | 37 | 142 |
| 6-G | 200 | 2.0 | 30 | 34 | 53 |
| 6-H | 200 | 2.4 | 47 | 33 | 92 |
| 6-I | 200 | 3.0 | 87 | 28 | 103 |

### Example 7

Additive Effect on Hydrothermal Crystallization of TiO₂ from Reagent Grade Ammonium Titanyl Oxalate Derived Titanyl Hydroxide Precipitate

A mixture consisting of 4-5 g of a reagent grade ammonium titanyl oxalate derived titanyl hydroxide precipitate (refer to Example 1 for precipitate preparation and characterization) and 0.025 g of a mineralizing salt (as shown in Table 7-1) was diluted with deionized water to a concentration of 4-5 grams of TiO₂ per 100 grams of slurry. A small amount of acid (as shown in Table 7-1) was added to the mixture to lower its pH to approximately 1. The acidic mixture containing the titanium precipitate and the mineralizing salt was charged into a 10 mL gold tube with a welded bottom. The top of the gold tube was then crimped, and the tube inserted vertically into a 1 L pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50-60 psig of argon pressure was brought into the reactor prior to heat-up. The added argon pressure, along with the autogenous hydrothermal pressure was contained inside the sealed reaction vessel. The reactor was heated to an internal temperature of 250° C. via the use of an external electrical heating jacket and held at this temperature for 16 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours, and the resulting TiO₂ powder was characterized by X-ray powder diffraction and particle size distribution. The product characterization data showed that among the 18 tested mineralizing salts, ZnCl₂, ZnO, MgCl₂, and NaCl were found to promote both rutile formation and the growth of equiaxed TiO₂ crystals. Additives KBr, KCl, LiCl, SnCl₄, ZnF₂, NH₄F, and NaF were found to be rutile phase directing but had no significant effect on crystal morphology. KH₂PO₄, Al₂(SO₄)₃, ZnSO₄, and Na₂SO₄ favored the formation of the anatase phase, while the presence of AlCl₃, Al₂O₃, and Al(OH)₃ negatively affected the formation and growth of the TiO₂ particles.

TABLE 7-1
Additive Effect on TiO₂ Formation

| | | | TiO₂ Product | | |
|---|---|---|---|---|---|
| | | | | Domain | |
| | | | | Size | d₅₀ |
| Sample | Additive | Acid | Phase* | (nm) | (nm) |
| 7-A | N/A | HCl | 100% R | 36 | 144 |
| 7-B | ZnCl₂ | HCl | 100% R | 41 | 185 |
| 7-C | ZnO | HCl | 100% R | 47 | 179 |
| 7-D | MgCl₂•6H₂O | HCl | 100% R | 42 | 145 |
| 7-E | NaCl | HCl | 100% R | 40 | 144 |
| 7-F | KBr | HCl | 100% R | 39 | 152 |
| 7-G | KCl | HCl | 98% R; 2% A | 29 | 117 |
| 7-H | LiCl | HCl | 100% R | 37 | 147 |
| 7-I | SnCl₄ | HCl | 100% R | 26 | 112 |
| 7-J | ZnF₂ | HCl | 100% R | 32 | 132 |
| 7-K | NH₄F | HCl | 88% R; 12% A | 30 | 124 |
| 7-L | NaF | HCl | 90% R; 10% A | 31 | 131 |
| 7-M | KH₂PO₄ | HCl | 100% A | 19 | 68 |
| 7-N | Al₂(SO₄)₃ | H₂SO₄ | 100% A | 13 | 47 |
| 7-O | ZnSO₄•H₂O | H₂SO₄ | 100% A | 14 | 51 |
| 7-P | Na₂SO₄ | H₂SO₄ | 100% A | 13 | 49 |
| 7-Q | AlCl₃•6H₂O | HCl | 77% R; 9% A, | 23 | 73 |
| | | | 14% B | | |
| 7-R | alpha-Al₂O₃ | HCl | 50% R; 28% A, | 18 | 36 |
| | | | 22% B | | |
| 7-S | Al(OH)₃ | HCl | 23% R; 56% A, | 14 | 48 |
| | | | 21% B | | |

*R = Rutile; A = Anatase; B = Brookite
Rutile/anatase mixtures were quantified using a calibrated XPD technique based on multiple known standard mixtures. Rutile/anatase/brookite mixtures were estimated using Whole Pattern Fitting (WPF) and Rietveld refinement of crystal structures in JADE ® XPDanalysis software (JADE ® v.6.1 © 2006 by Materials Data, Inc., Livermore, CA).

### Example 8

Reaction pH Effect on Hydrothermal Crystallization of TiO₂ from Reagent Grade Ammonium Titanyl Oxalate Derived Titanyl Hydroxide Precipitate

A mixture consisting of 3 g of a reagent grade ammonium titanyl oxalate derived titanyl hydroxide precipitate (refer to Example 1 for precipitate preparation and characterization) and a small amount of ZnCl₂ (reagent grade, CAS#7646-85-7, as shown in Table 8-1) was diluted with deionized water to a concentration of 3-4 grams of TiO₂ per 100 grams of slurry. Varying amounts of a dilute HCl solution were added to the titanyl hydroxide slurry as reported in Table 8-1. The mixture was then charged into a 10 mL gold tube with a welded bottom. The top of the gold tube was crimped, and the tube inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. The added argon pressure, along with the autogenous hydrothermal pressure was contained inside the sealed reaction vessel. The reactor was heated to an internal temperature of 250° C. via the use of an external electrical heating jacket and held at this temperature for 16 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours, and the resulting TiO₂ powder was characterized by X-ray powder diffraction and particle size distribution. The product characterization data indicated that under hydrothermal reaction conditions, control of reaction pH was critical to determining TiO₂ crystal phase and morphology. An increase in HCl concentration favored the formation of rutile but had a negative impact on TiO₂ crystal growth. Pigmentary rutile TiO₂ was observed at an acid concentration of 0.0018 moles of HCl per 3 g of titanyl hydroxide precipitate (8-B). Increasing the HCl concentration further led to the production of nano-size rutile TiO₂.

TABLE 8-1
REACTION PH EFFECT ON TIO₂ FORMATION

| | | | TiO₂ Product | | |
|---|---|---|---|---|---|
| | | | | Domain | |
| | HCl | ZnCl₂ | Phase | Size | d₅₀ |
| Example | (mol) | (g) | (% Rutile) | (nm) | (nm) |
| 8-A | 0.0007 | 0.2301 | 68 | 35 | 117 |
| 8-B | 0.0018 | 0.1447 | 100 | 52 | 584 |
| 8-C | 0.0028 | 0.0735 | 100 | 44 | 233 |
| 8-D | 0.0038 | 0.2896 | 100 | 36 | 142 |

### Example 9

Seeding Effect on Hydrothermal Crystallization of TiO₂ from Capel Ilmenite Ore Derived Titanyl Hydroxide Precipitate

A mixture consisting of 2.7 g of a Capel ilmenite ore (Iluka, Australia) derived titanyl hydroxide precipitate (15 wt % solid), 0.0583 g of ZnCl₂ (reagent grade, CAS#7646-85-7), 0.02 g of a rutile seed derived from TiOCl₂ (100% rutile by X-ray powder diffraction; d₁₀=56 nm, d₅₀=86 nm, d₉₀=143 nm), and 2.9 g of a dilute HCl solution was diluted with deionized water to a concentration of 4 grams of TiO₂ per 100 grams of slurry. The dilute HCl solution was prepared by combining 2.8 g of a 12.1N reagent grade HCl solution (CAS#7647-01-0) and 48.9 g of deionized water. The mixture containing the ore derived titanium precipitate and the rutile seed was added to a 10 mL gold tube with a welded bottom. The top of the gold tube was then crimped, and the tube was inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. This added argon pressure, along with the autogenous hydrothermal pressure was contained inside the sealed reaction vessel. The reactor was heated to an internal temperature of 250° C. via the use of an external electrical heating jacket and held at this temperature for 24 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours, and the resulting TiO₂ powder was characterized by X-ray powder diffraction and particle size distribution. The TiO₂ product (9-A) was 97% rutile with an average crystal domain size of 30 nm as determined by X-ray powder diffraction. The material had a bi-modal particle size distribution and a d₅₀ of 155 nm (d₁₀=99 nm; d₉₀ =4893 nm). For comparison, an unseeded TiO₂ product (9-B) was also synthesized under the same hydrothermal reaction conditions. The unseeded TiO₂ was 68% rutile with an average crystal domain size of 40 nm as determined by X-ray powder diffraction. The material also exhibited a bi-modal particle size distribution with a d₅₀ of 462 nm (d₁₀=162 nm; d₉₀=3513 nm). The data suggest that the presence of the TiOCl₂ derived rutile seed promotes the formation of the rutile phase but negatively impacts TiO₂ particle growth.

TABLE 9-1
Seeding Effect on Hydrothermal Crystallization of Tio₂
from Capel Ilmenite Ore Derived Titanyl Hydroxide Precipitate

| | | | | TiO₂ Product | | |
|---|---|---|---|---|---|---|
| | Rutile | | | | Domain | |
| | Seed | Dilute | ZnCl₂ | Phase | Size | d₅₀ |
| Example | (g) | HCl (g) | (g) | (% Rutile) | (nm) | (nm) |
| 9-A | 0.02 | 2.9 | 0.0583 | 97 | 30 | 155 |
| 9-B | 0.00 | 2.9 | 0.0583 | 68 | 40 | 462 |

### Example 10

Oxalate Effect on Hydrothermal Crystallization of TiO₂ from Reagent Grade Ammonium Titanyl Oxalate Derived Titanyl Hydroxide Precipitate

A mixture consisting of 4 g of a reagent grade ammonium titanyl oxalate derived titanyl hydroxide precipitate (refer to Example 1 for precipitate preparation and characterization) and a small amount of a dilute HCl solution (as shown in Table 10-1) was diluted with deionized water to a concentration of 7-8 grams of TiO₂ per 100 grams of slurry. The dilute HCl solution was prepared by combining 4.3 g of a 12.1N reagent grade HCl solution (CAS#7647-01-0) with 14.5 g of water. Varying amounts of Na₂C₂O₄ were added to the titanyl hydroxide slurry to adjust its oxalate concentration. The grams of Na₂C₂O₄ (reagent grade, CAS#62-76-0) added are reported in Table 10-1. The mixture was then charged into a 10 mL gold tube with a welded bottom. The top of the gold tube was crimped, and the tube inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. The added argon pressure, along with the autogenous hydrothermal pressure was contained inside the sealed reaction vessel. The reactor was heated to an internal temperature of 250° C. via the use of an external electrical heating jacket and held at this temperature for 16 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours, and the resulting TiO₂ powder was characterized by X-ray powder diffraction and particle size distribution. Based on the product characterization data, the presence of oxalate in the initial titanyl hydroxide mixture was found to promote the formation of the rutile phase under hydrothermal reaction conditions; however, the TiO₂ particle size decreased with increasing initial oxalate concentration.

TABLE 10-1
Oxalate Effect on TiO₂ Formation

| | | | TiO₂ Product | | |
|---|---|---|---|---|---|
| | Dilute | | | Domain | |
| | HCl | Na₂C₂O₄ | Phase | Size | d₅₀ |
| Example | (g) | (g) | (% Rutile) | (nm) | (nm) |
| 10-A | 0.8 | 0 | 60 | 51 | 68 |
| 10-B | 0.8 | 0.157 | 90 | 18 | 54 |
| 10-C | 1.8 | 0 | 100 | 39 | 400 |
| 10-D | 1.8 | 0.080 | 100 | 31 | 131 |

### Example 11

### Hydrothermal Crystallization of Brookite TiO₂

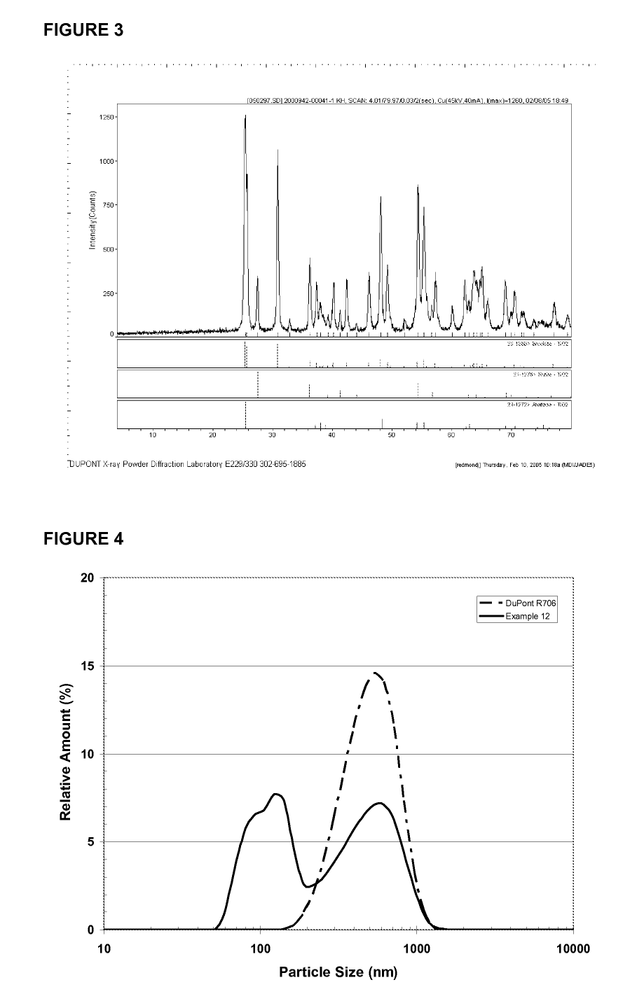

A mixture consisting of 80 g of a Capel ilmenite ore (Iluka, Australia) derived titanyl hydroxide precipitate, 8 g of concentrated NH₄OH solution (28-30 wt % NH₃, CAS# 1336-21-6), 0.4 g of a nano-size rutile seed (100% rutile by X-Ray powder diffraction: d₁₀=118 nm, d₅₀=185 nm, d₉₀=702 nm), and 173 g of deionized water was added to a 1 L PTFE lined Hastelloy® B-3 pressure vessel. The wetted reactor components, including the thermowell, agitator shaft, and impeller were made of Zr-702 metal to minimize TiO₂ contamination by metal corrosion products under elevated temperature and pH conditions. 90 psig argon pressure was brought into the reactor prior to heat-up. The added argon pressure, along with the autogenous hydrothermal pressure was contained inside the sealed reaction vessel. The reaction mixture was agitated by a pitch blade impeller at a constant speed of 90 rpm. The reactor was heated to an internal temperature of 220° C. via the use of an external electrical heating jacket and held at this temperature for 8 hours. The reactor internal temperature was measured by a thermocouple inside the reactor thermowell, which was immersed in the reaction mixture. After the completion of the hydrothermal crystallization reaction, the TiO₂ slurry was recovered from the reactor and found to have a pH of 9.5. The slurry was combined with 160 g of deionized water and charged into a 1 L round bottom flask. The mixture was agitated via a magnetic stir bar at a temperature of 80° C. for approximately 5 hours under reflux conditions. The TiO₂ slurry was then filtered via a 0.2 μm disposable nylon filter cup while it was still hot. The resulting wet TiO₂ cake was washed thoroughly with 80° C. deionized water, and it was then dried in a 75° C. vacuum oven for approximately 12 hours to yield 8 g of TiO₂ powder. The recovered TiO₂ product contained as much as 25% amorphous material as determined by X-ray powder diffraction (XPD). The relative amount of the three crystalline TiO₂ phases in this product (see FIG. 3) was estimated using Whole Pattern Fitting (WPF) and Rietveld refinement of crystal structures in JADE® XPD analysis software (JADE® v.6.1 ©2006 by Materials Data, Inc., Livermore, Calif.). This analysis indicated the recovered crystalline product consisted of 10% rutile, 10% anatase, and 80% brookite. The material exhibited a mono-modal particle size distribution and a d₅₀ of 86 nm (d₁₀=49 nm; d₉₀=159 nm).

### Example 12

Hydrothermal Crystallization of Pigmentary Rutile TiO₂ at 250° C. from Titanyl Sulfate (TiOSO₄) Derived Titanyl Hydroxide Precipitate

A mixture consisting of 3.4 g of a reagent grade titanyl sulfate derived amorphous titanyl hydroxide precipitate (12 wt % solid, 0.00 wt % carbon, 0.62 wt % nitrogen), 0.0582 g of ZnCl₂ (reagent grade, CAS# 7646-85-7), and 2.2 mL of a 0.96N HCl solution was diluted with deionized water to a concentration of 4 grams of TiO₂ per 100 grams of slurry. The mixture was added to a 10 mL gold tube with a welded bottom. The top of the gold tube was then crimped, and the tube was inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. This added argon pressure, along with the autogenous hydrothermal pressure was contained inside the sealed reaction vessel. The reactor was heated to an internal temperature of 250° C. via the use of an external electrical heating jacket and held at this temperature for 24 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours to yield 0.32 g of TiO₂ powder. The recovered TiO₂ product was >99% rutile with an average crystal domain size of 58 nm as determined by X-ray powder diffraction. The material exhibited a bi-modal particle size distribution with a significant percentage of the particles in the pigmentary range of 500-1000 nm (d₁₀=92 nm; d₅₀=284 nm; d₉₀=789 nm) (refer to FIG. 4).

### Example 13

Hydrothermal Crystallization of Nano-Size Rutile TiO₂ at 250° C. from Titanium Oxychloride (TiOCl₂) Derived Titanyl Hydroxide Precipitate

A mixture consisting of 4.0 g of a reagent grade titanium oxychloride derived amorphous titanyl hydroxide precipitate (10 wt % solid, 0.00 wt % carbon, 0.55 wt % nitrogen), 0.0584 g of ZnCl₂ (reagent grade, CAS#7646-85-7), and 2.5 mL of a 0.96N HCl solution was diluted with deionized water to a concentration of 3 grams of TiO₂ per 100 grams of slurry. The mixture was added to a 10 mL gold tube with a welded bottom. The top of the gold tube was then crimped, and the tube was inserted vertically into a 1 L Zr-702 pressure vessel. To facilitate heat transfer inside the 1 L reactor, water was added to submerge the bottom half of the inserted gold tube. The reactor thermowell was also immersed in water, and it contained a thermocouple for determining the reactor internal temperature. 50 psig argon pressure was brought into the reactor prior to heat-up. This added argon pressure, along with the autogenous hydrothermal pressure was contained inside the sealed reaction vessel. The reactor was heated to an internal temperature of 250° C. via the use of an external electrical heating jacket and held at this temperature for 24 hours without agitation. After the completion of the hydrothermal reaction, the TiO₂ slurry was recovered from the gold tube and warmed to 35° C. on a hot plate. It was then filtered via a 0.2 μm nylon membrane and washed with deionized water. The wet TiO₂ cake was dried in a 75° C. vacuum oven for 13-14 hours to yield 0.24 g of TiO₂ powder. The recovered TiO₂ product was 100% rutile with an average crystal domain size of 30 nm as determined by X-ray powder diffraction. The material exhibited a mono-modal particle size distribution with a d₅₀ of 125 nm (d₁₀=83 nm; d₉₀=207 nm).

In Examples 14 to 24, the crystallization of TiO₂ particles was carried out hydrothermally in the presence of strong acids and various metal chloride mineralizers. Amorphous hydrous titanium oxide precipitate (sometimes represented as TiO(OH)₂.nH₂O with n˜32, (Example 1 provides precipitate preparation and characterization) was added to water to produce a slurry typically in the 33-50 weight % range. These slurries were acidified with strong mineral acids to give pH values typically in the 1-2 range. In certain experiments, metal chloride salts were added at levels ranging from 0.5 to 20% of the weight of the amorphous TiO(OH)₂.nH₂O. The mixtures were placed into gold reaction tubes, which were then crimped closed, as opposed to sealed, to allow for pressure equilibration. The gold tube with its contents was then placed into an autoclave. The temperature of the experiments ranged from 250 to 350° C. and the pressure was autogenous, ranging from 40 to 170 atmospheres, respectfully. Typical reaction times varied from 1 to 72 hours with a preferred time of between 18 to 24 hrs. Under various experimental conditions, listed herein, faceted rutile TiO₂ primary particles of pigmentary dimensions could be produced.

There was a strong correlation between average crystallite size and primary particle size. From the scanning electron micrographs, the primary particles were essentially the pigment particles. Secondary particles were loosely agglomerated primaries. PSD measurement alone without electron microscopy confirmation was highly problematic. The wide breadth of particle size was most likely associated with concentration gradients owing to lack of agitation. Mineralizer affected not only primary particle size, but also crystalline phase formation and crystal habit. The presence of chloride tended to result in the formation of equiaxed rutile particles, nitrate tended to form acicular rutile particles, and sulfate forms anatase. The presence of ZnCl₂ mineralizer resulted in the formation of pigmentary particles at lower temperature. The presence of ZnCl₂ mineralizer also resulted in a higher degree of agglomeration of the primary particles.

### Example 14

Hydrothermal Crystallization of Pigmentary Rutile TiO₂ at 350° C. from Ammonium Titanyl Oxalate-Derived Titanyl Hydroxide Precipitate

A mixture consisting of 20.0 grams of an ammonium titanyl oxalate-derived titanyl hydroxide precipitate and 100 ml of a 0.1N HCl solution was charged into a 125 ml glass vessel specifically designed to fit into a high pressure autoclave (maximum pressure rating=1000 atmospheres). The glass vessel incorporated an open trap to allow for pressure equilibration. The pH of the mixture prior to crystallization was 2.3. The sealed autoclave was externally heated to 350° C. and developed an autogenous hydrothermal pressure of 172 atmospheres. The autoclave was held at temperature for 16 hours without agitation. After the completion of the hydrothermal reaction, the resultant TiO₂ slurry was recovered from the glass vessel, filtered and washed with de-ionized water, and allowed to air dry. The recovered TiO₂ product was predominantly rutile (84% rutile/16% anatase) with an average crystal domain size of 38.5 nm as determined by X-ray powder diffraction. Scanning electron microscopy images of the TiO₂ product revealed equiaxed primary particles of pigmentary size, on the order of 200-500 nm. The material exhibited a mono-modal particle size distribution with a significant percentage of the particles in the pigmentary range of 500-1000 nm (d₁₀=414 nm; d₅₀=732 nm; d₉₀=1183 nm).

### Example 15

Hydrothermal Crystallization of Pigmentary Rutile TiO₂ at 350° C. from Ammonium Titanyl Oxalate-Derived Titanyl Hydroxide Precipitate

A mixture consisting of 6.0 grams of an ammonium titanyl oxalate-derived titanyl hydroxide precipitate and 10 ml of a 1.0 N HCl solution was charged into a 15 ml gold tube with a welded bottom. The top of the gold tube was then crimped to allow for pressure equilibration, and the tube was inserted vertically into a high-pressure autoclave (maximum pressure rating=1000 atmospheres). The pH of the mixture prior to crystallization was 1.3. The sealed autoclave was externally heated to 350° C. and developed an autogenous hydrothermal pressure of 163 atmospheres. The autoclave was held at temperature for 16 hours without agitation. After the completion of the hydrothermal reaction, the resultant TiO₂ slurry was recovered from the gold tube, filtered and washed with de-ionized water, and allowed to air dry. The recovered TiO₂ product was 100% rutile with an average crystal domain size of 56.9 nm as determined by X-ray powder diffraction. Scanning electron microscopy images of the TiO₂ product revealed a majority of equiaxed primary particles of pigmentary size, on the order of 200-500 nm, and some super-pigmentary-sized primary particles (≧1 μm). The material exhibited a mono-modal particle size distribution with a significant percentage of the particles in the pigmentary range of 500-1000 nm (d₁₀=358 nm; d₅₀=746 nm; d₉₀=1378 nm).

### Example 16

Hydrothermal Crystallization of Pigmentary Rutile TiO₂ at 350° C. from Capel Ilmenite Ore (Iluka, Australia)-Derived Titanyl Hydroxide Precipitate

A mixture consisting of 6.0 grams of a Capel ilmenite ore (Iluka, Australia)-derived titanyl hydroxide precipitate and 10 ml of a 1.0 N HCl solution was charged into a 15 ml gold tube with a welded bottom. The top of the gold tube was then crimped to allow for pressure equilibration, and the tube was inserted vertically into a high-pressure autoclave (maximum pressure rating=1000 atmospheres). The sealed autoclave was externally heated to 350° C. and developed an autogenous hydrothermal pressure of 165 atmospheres. The autoclave was held at temperature for 16 hours without agitation. After the completion of the hydrothermal reaction, the resultant TiO₂ slurry was recovered from the gold tube, filtered and washed with de-ionized water, and allowed to air dry. The recovered TiO₂ product was 100% rutile with an average crystal domain size of 42.3 nm as determined by X-ray powder diffraction. Scanning electron microscopy images of the TiO₂ product revealed a majority of equiaxed primary particles of pigmentary size, on the order of 200-500 nm, and some super-pigmentary-sized primary particles (≧1 μm). The material exhibited a bi-modal particle size distribution with a significant percentage of the particles in the pigmentary range of 500-1000 nm (d₁₀=99 nm; d₅₀=156 nm; d₉₀=622 nm).

### Example 17

Hydrothermal Crystallization of Anatase TiO₂ at 350° C. from Ammonium Titanyl Oxalate-Derived Titanyl Hydroxide Precipitate

A mixture consisting of 6.0 grams of an ammonium titanyl oxalate-derived titanyl hydroxide precipitate and 6 ml of a 0.2 N HCl solution was charged into a 15 ml gold tube with a welded bottom. The top of the gold tube was then crimped to allow for pressure equilibration, and the tube was inserted vertically into a high-pressure autoclave (maximum pressure rating=1000 atmospheres). The pH of the mixture prior to crystallization was 4.7. The sealed autoclave was externally heated to 350° C. and developed an autogenous hydrothermal pressure of 170 atmospheres. The autoclave was held at temperature for 16 hours without agitation. After the completion of the hydrothermal reaction, the resultant TiO₂ slurry was recovered from the gold tube, filtered and washed with de-ionized water, and allowed to air dry. The recovered TiO₂ product was 100% anatase with an average crystal domain size of 20.3 nm as determined by X-ray powder diffraction.

### Example 18

Hydrothermal Crystallization of Nano-Sized Rutile TiO₂ at 250° C. from Ammonium Titanyl Oxalate-Derived Titanyl Hydroxide Precipitate

A mixture consisting of 6.0 grams of an ammonium titanyl oxalate-derived titanyl hydroxide precipitate and 10 ml of a 1.0 N HNO₃ solution was charged into a 15 ml gold tube with a welded bottom. The top of the gold tube was then crimped to allow for pressure equilibration, and the tube was inserted vertically into a high-pressure autoclave (maximum pressure rating=1000 atmospheres). The pH of the mixture prior to crystallization was 2.2. The sealed autoclave was externally heated to 250° C. and developed an autogenous hydrothermal pressure of 39 atmospheres. The autoclave was held at temperature for 16 hours without agitation. After the completion of the hydrothermal reaction, the resultant TiO₂ slurry was recovered from the gold tube, filtered and washed with de-ionized water, and allowed to air dry. The recovered TiO₂ product was 100% rutile with an average crystal domain size of 27.0 nm as determined by X-ray powder diffraction. Scanning electron microscopy images of the TiO₂ product revealed a majority of nano-sized acicular primary particles, on the order of 100 nm in length with an aspect ratio (length/width) of between 2 and 5. The material exhibited a mono-modal particle size distribution with the majority of the particles in the nano-sized range of 50-200 nm (d₁₀=77 nm; d₅₀=115 nm; d₉₀=171 nm).

### Example 19

Hydrothermal Crystallization of Anatase TiO₂ at 350° C. from Ammonium Titanyl Oxalate-Derived Titanyl Hydroxide Precipitate

A mixture consisting of 6.0 grams of an ammonium titanyl oxalate-derived titanyl hydroxide precipitate and 10 ml of a 1.0 N H₂SO₄ solution was charged into a 15 ml gold tube with a welded bottom. The top of the gold tube was then crimped to allow for pressure equilibration, and the tube was inserted vertically into a high-pressure autoclave (maximum pressure rating=1000 atmospheres). The pH of the mixture prior to crystallization was 1.6. The sealed autoclave was externally heated to 350° C. and developed an autogenous hydrothermal pressure of 170 atmospheres. The autoclave was held at temperature for 16 hours without agitation. After the completion of the hydrothermal reaction, the resultant TiO₂ slurry was recovered from the gold tube, filtered and washed with de-ionized water, and allowed to air dry. The recovered TiO₂ product was 100% anatase with an average crystal domain size of 44.5 nm as determined by X-ray powder diffraction. The material exhibited a bi-modal particle size distribution (d₁₀=98 nm; d₅₀=154 nm; d₉₀=700 nm).

### Example 20

Hydrothermal Crystallization of Pigmentary TiO₂ at 350° C. from Ammonium Titanyl Oxalate-Derived Titanyl Hydroxide Precipitate with 0.5 Mol % Mineralizers

Mixtures consisting of 6.0 grams of an ammonium titanyl oxalate-derived titanyl hydroxide precipitate, 0.5 mol % a) LiCl, b) NaCl, and c) SnCl₄ mineralizers, and 10 ml of a 1.0 N HCl solution were each charged into 15 ml gold tubes with a welded bottom. The top of the gold tubes was then crimped to allow for pressure equilibration, and the tubes were inserted vertically into a high-pressure autoclave (maximum pressure rating=1000 atmospheres). The pH of the mixtures prior to crystallization was 1.3. The sealed autoclave was externally heated to 350° C. and developed an autogenous hydrothermal pressure of 157 atmospheres. The autoclave was held at temperature for 16 hours without agitation. After the completion of the hydrothermal reaction, the resultant TiO₂ slurries were recovered from the gold tubes, filtered and washed with de-ionized water, and allowed to air dry. The recovered TiO₂ products were 100% rutile. Average crystal domain sizes of 54.5 (LiCl), 64.6 (NaCl), and 54.7 (SnCl₄) nm, were determined by X-ray powder diffraction. These materials exhibited bi-modal particle size distributions (LiCl: d₁₀=122 nm; d₅₀=307 nm; d₉₀=818 nm; NaCl: d₁₀=153 nm; d₅₀32 523 nm; d₉₀=1026 nm; SnCl₄: d₁₀=84 nm; d₅₀=169 nm; d₉₀ =719 nm).

### Example 21

Hydrothermal Crystallization of Pigmentary and Super-Pigmentary TiO₂ at 350° C. from Ammonium Titanyl Oxalate-Derived Titanyl Hydroxide Precipitate with Increasing Mol % of NaCl Mineralizer

Mixtures consisting of 6.0 grams of an ammonium titanyl oxalate-derived titanyl hydroxide precipitate, a) 0, b) 10, and c) 20 mol % NaCl mineralizer, and 10 ml of a 1.0 N HCl solution were each charged into 15 ml gold tubes with a welded bottom. The top of the gold tubes was then crimped to allow for pressure equilibration, and the tubes were inserted vertically into a high-pressure autoclave (maximum pressure rating=1000 atmospheres). The sealed autoclave was externally heated to 350° C. and developed an autogenous hydrothermal pressure of 158 atmospheres. The autoclave was held at temperature for 16 hours without agitation. After the completion of the hydrothermal reaction, the resultant TiO₂ slurries were recovered from the gold tubes, filtered and washed with de-ionized water, and allowed to air dry. The recovered TiO₂ products were 100% rutile. Average crystal domain sizes of 31.1 (0 mol % NaCl), 44.8 (10 mol % NaCl), and 54.6 (20 mol % NaCl) nm, were determined by X-ray powder diffraction. The materials exhibited mono-modal, tri-modal, and mono-modal particle size distributions, respectively, (0 mol % NaCl: d₁₀=93 nm; d₅₀=131 nm; d₉₀ =192 nm; 10 mol % NaCl: d₁₀=58 nm; d₅₀=167 nm; d₉₀=572 nm; 20 mol % NaCl: d₁₀=349 nm; d₅₀=604 nm; d₉₀ =948 nm).

### Example 22

Hydrothermal Crystallization of Pigmentary and Super-Pigmentary TiO₂ at 350° C. from Ammonium Titanyl Oxalate-Derived Titanyl Hydroxide Precipitate at High Solids Loading—approximately 1 g TiO₂/ml concentrated HCl

A mixture consisting of 10.0 grams of an ammonium titanyl oxalate-derived titanyl hydroxide precipitate and 1 ml of a concentrated 12 N HCl solution was charged into a 15 ml gold tube with a welded bottom. The top of the gold tubes was then crimped to allow for pressure equilibration, and the tube was inserted vertically into a high-pressure autoclave (maximum pressure rating=1000 atmospheres). The sealed autoclave was externally heated to 350° C. and developed an autogenous hydrothermal pressure of 170 atmospheres. The autoclave was held at temperature for 16 hours without agitation. After the completion of the hydrothermal reaction, the resultant TiO₂ slurry was recovered from the gold tube, filtered and washed with de-ionized water, and allowed to air dry. The recovered TiO₂ product was 100% rutile. An average crystal domain size of 66.4 nm was determined by X-ray powder diffraction. The material exhibited a bi-modal particle size distribution (d₁₀=411 nm; d₅₀=784 nm; d₉₀=5503 nm).

### Example 23

Hydrothermal Crystallization of Pigmentary TiO₂ at 250° C. from Ammonium Titanyl Oxalate-Derived Titanyl Hydroxide Precipitate with ZnCl₂ Mineralizer

Mixtures consisting of 3.0 grams of an ammonium titanyl oxalate-derived titanyl hydroxide precipitate, 0.14 gram of ZnCl₂ mineralizer, and 2 ml of a 1.0 N HCl solution, and 4 ml of deionized water were each charged into 15 ml gold tubes with a welded bottom. The top of the gold tubes was then crimped to allow for pressure equilibration, and the tubes were inserted vertically into a high-pressure autoclave (maximum pressure rating=1000 atmospheres). The sealed autoclave was externally heated to 250° C. and developed an autogenous hydrothermal pressure of 39 atmospheres. The autoclave was held at temperature for 16 hours without agitation. After the completion of the hydrothermal reaction, the resultant TiO₂ slurries were recovered from the gold tubes, filtered and washed with de-ionized water, and allowed to air dry. The recovered TiO₂ products were 100% rutile. An average crystal domain size of 47.0 nm was determined by X-ray powder diffraction. The material exhibited a mono-modal particle size distribution (d₁₀=345 nm; d₅₀=669 nm; d₉₀=1108 nm).

### Example 24

Hydrothermal Crystallization of Pigmentary TiO₂ at 250° C. from Ammonium Titanyl Oxalate-Derived Titanyl Hydroxide Precipitate with MgCl₂ and CaCl₂ Mineralizer

Mixtures consisting of 6.0 grams of an ammonium titanyl oxalate-derived titanyl hydroxide precipitate, 0.43 grams of MgCl₂.6H₂O and 0.34 grams of CaCl₂.2H₂O mineralizer, respectively, 4 ml of a 1.0 N HCl solution, and 8 ml of deionized water were each charged into 15 ml gold tubes with a welded bottom. The top of the gold tubes was then crimped to allow for pressure equilibration, and the tubes were inserted vertically into a high-pressure autoclave (maximum pressure rating=1000 atmospheres). The sealed autoclave was externally heated to 250° C. and developed an autogenous hydrothermal pressure of 39 atmospheres. The autoclave was held at temperature for 16 hours without agitation. After the completion of the hydrothermal reaction, the resultant TiO₂ slurries were recovered from the gold tubes, filtered and washed with de-ionized water, and allowed to air dry. The recovered TiO₂ products were 100% rutile. An average crystal domain size of 54.4 nm for MgCl₂ and 42.5 nm for CaCl₂ was determined by X-ray powder diffraction. The materials exhibited bi-modal particle size distributions (MgCl₂: d₁₀=75 nm; d₅₀=654 nm; d₉₀=1317 nm and CaCl₂: d₁₀=99 nm; d₅₀=162 nm; d₉₀=612 nm).

What is claimed is:

1. A process comprising:
f) mixing amorphous titanyl hydroxide with water to obtain a titanium-containing slurry;
g) adding to the titanium-containing slurry 0.16 to 20 weight percent of a free acid selected from the group consisting of HCl, H₂C₂O₄.2H₂O, HNO₃, HF, and HBr to form an acidified titanium-containing slurry;
h) adding to the acidified titanium-containing slurry 0.01 to 15 weight percent of a rutile-directing additive to form a mixture;
i) heating the mixture to a temperature of at least 150° C. but less than 374° C. for less than 24 hours in a closed vessel to form rutile and a residual solution; and
j) separating the rutile from the residual solution.

2. The process of claim 1 wherein the rutile-directing additive is selected from the group consisting of halides, oxalates, oxides, and hydroxides of zinc, tin, ammonium, and the group I and group II metals.

3. A process comprising:
f) mixing amorphous titanyl hydroxide with water to obtain a titanium-containing slurry;
g) adding to the titanium-containing slurry 0.16 to 0.41 wt % of a free acid selected from the group consisting of HCl, HNO₃, HF, H₂C₂O₄.2H₂O, and HBr to form an acidified titanium-containing slurry;
h) adding to the acidified titanium-containing slurry 0.5 to 15 weight percent of a pigmentary rutile-directing additive to form a mixture;
i) heating the mixture to a temperature of at least 220° C. but less than 374° C. for 24 hours or less in a closed vessel to form pigmentary rutile and a residual solution; and
j) separating the pigmentary rutile from the residual solution.

4. The process of claim 3 wherein the pigmentary rutile-directing additive is selected from the group consisting of halides, oxalates, oxides, and hydroxides of zinc, tin, ammonium, and the group I and group II metals.

5. The process of claim 3 wherein the pigmentary rutile-directing additive is selected from the group consisting of ZnCl₂, ZnO, MgCl₂, and NaCl.

6. A process comprising:
a) mixing amorphous titanyl hydroxide with water to obtain titanium-containing slurry;
b) adding to the titanium-containing slurry 0.3 to 20 weight percent of a free acid selected from the group consisting of HCl, H₂C₂O₄.2H2O, HNO₃, HF, and HBr to form an acidified titanium-containing slurry;
c) adding 0.01 to 15 weight percent of a rutile-directing additive selected from the group consisting of the halides, oxalates, oxides, and hydroxides of zinc, tin, ammonium and the group I and group II metals to the acidified titanium-containing slurry to form a mixture;
d) heating the mixture to a temperature of at least 150° C. but less than 250° C. for less than 24 hours in a closed vessel to form nano rutile and a residual solution;
e) separating the nano rutile from the residual solution.

7. The process of claim 6 wherein the rutile-directing additive is selected from the group consisting of halides, oxalates, oxides, and hydroxides of zinc, tin, ammonium, and the group I and group II metals

8. A process comprising:
f) mixing amorphous titanyl hydroxide with water to obtain a titanium-containing slurry;
g) optionally adding less than 0.16 wt % of an acid selected from the group consisting of HCl, HF, HBr, HNO₃, and H₂C₂O₄.2H₂O or up to 20 wt. % of H₂SO₄ to the titanium-containing slurry to form an acidified slurry;
h) adding 0.01-15 weight percent of an anatase-directing additive to the slurry to form a mixture;
i) heating the mixture to a temperature of at least 150° C. but less than 374° C. for 24 hours or less in a closed vessel to form anatase and a residual solution;
j) separating the anatase from the residual solution.

9. The process of claim 8 wherein the anatase-directing additive is selected from the group consisting of KH₂PO₄, Al₂(SO₄)₃, ZnSO₄, and Na₂SO₄.

10. A process comprising:
a) mixing amorphous titanyl hydroxide with water to obtain a titanium-containing slurry;
b) adding a NH₄OH/NH₃ solution to the titanium-containing slurry such that the slurry has a pH greater than 9.0;
c) adding to the slurry 0.01 to 15 weight percent of a brookite-directing additive to the titanium-rich slurry to form a mixture;
d) heating the mixture to a temperature of at least 150° C. but less than the 374° C. for 24 hours or less in a closed vessel to form brookite and a residual solution;
e) separating the brookite from the residual solution.

11. The process of claim 10 wherein the brookite-directing additive is selected from the group consisting of AlCl₃.6H₂O, alpha-Al₂O₃, Al(OH)₃, and AlOOH.
